(19) United States
(12) Patent Application Publication
(10) Pub. No.: US 2019/0357695 A1
(43) Pub. Date: Nov. 28, 2019

(54) COMPOSITE OBJECT COMPRISING A BODY AND A FOAM, AND METHOD FOR PRODUCTION THEREOF

(71) Applicant: Covestro Deutschland AG, Leverkusen (DE)

(72) Inventors: Dirk Achten, Leverkusen (DE); Thomas BÜSGEN, Leverkusen (DE); Rolf ALBACH, Köln (DE); Levent AKBAS, Witten (DE)

(21) Appl. No.: 16/334,086

(22) PCT Filed: Sep. 22, 2017
(86) PCT No.: PCT/EP2017/074008

§ 371 Date: Mar. 18, 2019

(30) Foreign Application Priority Data
Sep. 23, 2016 (EP) 16190416.4

(51) Int. Cl. A47C 27/16; B33Y 10/00

(52) U.S. Cl. CPC A47C 27/16; B33Y 80/00; B33Y 10/00

(57) ABSTRACT

The present invention relates to novel anisotropic composite materials and processes for production thereof. The composite materials are based on the crosslinking of polyisocyanates and feature good weathering stability.

The present invention relates to a composite article comprising a body and a foam, to the use thereof as a supporting element or mounting element and to a process for producing such a composite article.

Supporting elements or mounting elements may be in the form of mattresses for example. Such mattresses typically consist of foam materials, wherein the mattresses in particular may consist of a plurality of superposed foam layers. In order to increase the reclining comfort of such mattresses it is customary to undertake so-called zoning in mattresses. Such zoning comprises forming zones having varying elastic properties, i.e. varying compliancy, distributed over the area of the mattress. This takes account of the fact that a mattress should have a different compliancy in the leg region for example than in the back region. In order to form such zonings in multi-layered mattresses local cavities are typically incorporated into a middle mattress layer with oscillating blades. Completely closed upper and lower mattress layers are then applied to each of the top side and bottom side of this middle mattress layer.

DE 10 2015 100 816 B3 discloses a process for producing a body-supporting element formed by a mattress, a cushion, a seat or part of a seat, comprising the process steps of defining print data which form a person-specific three-dimensional support structure and the production of the body-supporting element using the print data by means of a 3D printer. Using the print data, it is possible to produce regions of different elasticity through the formation of cavities of different sizes and/or different number by means of the 3D printer.

It is stated that, in the process according to DE 10 2015 100 816 B3, production of the body-supporting element can be accomplished using elastic materials which, in the printing process performed with the 3D printer, are mixed with a binder. Employable elastic materials include elastomeric materials, especially plastics. The 3D printer may have spraying means, wherein elastic materials are sprayed from first spraying means and binders are sprayed from second spraying means. The elastic materials may be in powder form.

DE 10 2015 100 816 B3 gives no indications as to whether the elastomeric material forms a porous body. It is stated that, by means of the 3D printer, according to the print data, regions of different elasticity of the body-supporting element are generated through the formation of cavities of different sizes and/or different number. In order to obtain spatial variation of the elasticity of the mattress 3 cavities may in the 3D printer be specifically incorporated at certain sites in the mattress. A cavity at a particular site is generated when no binder is sprayed via the second spraying means, so that the elastomeric material sprayed via the first spraying means cannot bond with the binder to afford a material structure there. It is also alternatively possible not to spray any elastomeric material via the first spraying means, so that no pulverulent elastomeric material is wasted.

DE 10 2015 100 816 B3 states that the cavities generated with the 3D printer may have any desired geometries and these may especially be in the form of inclusions that may be surrounded on all sides by the material structure of the mattress. It is also intimated that the cavities may be generated in different sizes, and in particular also very small cavities may be generated, and it is thus said to be possible to achieve a particularly high spatial resolution of the variation in elastic properties of the mattress.

Flexible polyurethane foams have traditionally been used in large quantities for the production of mattresses, cushions and the like and this is documented in numerous patent and non-patent publications. By contrast, reports relating to materials that could be characterized as foams produced by additive processes are less common.

The publication by Maitik, et al. “3D printed cellular solid outperforms traditional stochastic foam in long-term mechanical response”, Sci. Rep. 6, 24871; doi: 10.1038/srep24871 (2016) describes materials formed from polydimethylsiloxane elastomer (PDMS) that are produced by means of the direct ink writing method. The material was constructed in layerwise fashion and each layer was composed of equally spaced PDMS cylinders of 250 μm in diameter.

WO 2012/028747 A1 relates to a process for producing a three-dimensional article from a construction material by an additive layer construction process, in which, proceeding from material characteristics of the construction material and from defined properties of the article to be manufactured, an internal structure of the object comprising a grid structure is calculated and the three-dimensional object having this internal structure is produced by the additive layer construction process and therefore has the defined properties.

The introduction of functionalities into a matrix material is practiced in many fields of technology. The functionalities usually here assume tasks of mechanical reinforcement of the overall body. One example is a steel-reinforced concrete in which steel grids introduced into the concrete can absorb tensile forces. Glass fiber- or carbon fiber-reinforced plastics resins are another example of such composite materials.

In the field of polymer foams it is known (DE 4446450 C1) that for the production of foam parts for backrests, seating areas and the like of vehicle seats, liquid polyurethane is injected into a mold which is subsequently closed and heated so that the polyurethane foams and the foam part takes the desired shape. In order that the covers may be attached to the seat/the foam part, so-called insert or trimming wires are foamed into the foam part, to which corresponding wires provided in the covers may be attached via clampable rings or the like. The trimming wires are inserted into the mold before introduction of the liquid polyurethane and held in the appropriate places in the mold via magnets and retaining pins so that they are not displaced during injection and foaming of the polyurethane. The trimming wires are, in this case, fully foamed into the foam part and voids remain only at the retaining points which allow access to the wires for subsequent attachment of the covers.

EP 0 991 514 A1 discloses an energy-absorbing article comprising a surface in which impact resistance is desired; built into the energy-absorbing article is an extruded thermoplastic foam which is a coalesced extruded foam having a higher strength in a first direction than in any other direction; wherein the extruded thermoplastic foam is oriented such that the first direction in which the strength is greatest is aligned approximately with the direction in which impact strength is desired. The thermoplastic foam may be a co-extrudate which includes foam extrudates and a uniform profile of an unfoamed thermoplastic material placed therebetween.

Polymer bodies having incorporated functionalities may in certain cases also be regarded as interpenetrating polymeric networks (IPN). Such networks in the application of a golf ball form the subject matter of patent application US 2002/187857 A1.

Finally, patent application CN 1331010 A discloses a multipurpose composite sheet for interior decoration purposes. The sheet is a foamed sheet constructed from a reinforcing scaffold and a foamed material which surrounds the reinforcing scaffold. Advantages described include a high strength and simple combination.

It is an object of the present invention to at least partially overcome at least one drawback of the prior art. It is a further object of the present invention to provide an article which may be comparable in terms of its perceived comfort for a user with a conventional mattress or a conventional cushion. It is yet a further object of the invention to be able to produce such an article in a manner which is as cost efficient and/or individualized and/or resource-saving as possible.

The object is achieved in accordance with the invention by a composite article as claimed in claim 1, a use as claimed in claim 13 and a process as claimed in claim 14. Advantageous developments are specified in the subsidiary claims. They may be combined as desired, unless the opposite is apparent from the context.

A composite article according to the invention comprises a body and a solid foam. The body has been produced by means of an additive manufacturing process and has at least a positive fit to the foam, wherein the material of the body is different from that of the foam.

As will be further intimated in the context of the process according to the invention the body is produced by means of an additive manufacturing process. The material of the body may comprise for example a metal, a ceramic including concrete, a polymer or, in the case of additive lamination processes, paper. Positive fit and optionally material joining of the foam with the body makes it possible to achieve synergistic mechanical properties for the composite article, in the context of the invention positive fit is to be understood as meaning that the body and the foam are in direct contact in at least one place. Positive fit is preferably further to be understood as meaning that the body and the foam prevent one another from moving in a spatial direction separately, i.e. they may only be moved together in one spatial direction. Material joins are to be understood as meaning all joins where the join partners, i.e. the body and the foam, are held together by atomic or molecular forces. They are simultaneously insoluble joins which are separable only by destruction of the joining means. Methods for obtaining material joins include for example soldering, welding, adhesive bonding, vulcanizing or a combination of at least two of these. Possible examples from the building or construction sector are 3D printed (partial) cavities such as walls which are at least partially foam-filled.

One preferred embodiment relates to a composite article comprising a body and a foam. The body comprises a spatial network of node points joined to one another by struts and a space present between the struts. The space present between the struts is at least partially occupied by a solid polymer foam. The body is at least partially formed from a polymeric material different from the polymer foam.

For example a viscoelastic foam together with an elastic body may realize a tailored damping element or a tailored mattress.

In the composite article according to the invention it is preferable when at least two struts, more preferably ≥10% of the struts to ≤99.9% of the struts, particularly preferably ≥70% of the struts to ≤99.9% of the struts are joined to one another by the polymer foam. This makes it possible to achieve an anchoring of the foam inside of the body or positive fitting to the body that is as tight as possible.

It is further preferable when there is a material join (for example with an adhesion of >0.5 N/mm) between the polymer foam and the struts. This may be achieved for example when the body is at least partially formed from a polyurethane polymer and the foam is a polyurethane foam.

The polymer foam is a solid polymer foam, wherein “solid” is to be understood as being distinct from “flowable”. The foam may be open-celled or closed-celled. Integral foams having a closed surface are also conceivable.

The ratio of the foam volume to the volume of the body defined by its external dimensions may be <1, 1 or >1. For example the foam may be inside the body and the body may have regions not filled by the foam. However, the body may also be fully embedded in the foam so that it does not protrude from the foam at any point.

In a preferred embodiment the body is fully embedded in the foam. It is preferable when the foam extends around the body at every point of the composite article by at least 0.1 cm or preferably by at least 0.5 cm or preferably by at least 1 cm. It is preferable when the foam extends around the body at every point of the composite article in a range of 0.5 to 50 cm or preferably in a range of 1 to 40 cm the body or preferably in a range of 2 to 30 cm or preferably in a range of 3 to 20 cm or preferably in a range of 4 to 10 cm.

According to the invention it is provided that the body is at least partially formed from a polymeric material different from the polymer foam. The difference may be based on physical properties (for example a different density) and/or on chemical properties (for example chemically distinct materials).

The body may be manufactured in an additive manufacturing process without external supporting elements during the vertical construction of its structure.

The space between the struts of the body may account for ≥50% to ≤99%, preferably ≥55% to ≤95%, more preferably ≥60% to ≤90%, of the volume of the body. When the density of the starting material for the body and the density of the body itself are known this parameter is easily determinable.

The average spatial density of the node points in the body may be for example ≥50 node points/m³ to ≤2000000 node points/m³, preferably ≥500 node points/cm³ to ≤1000000 node points/m³, more preferably ≥5000 node points/m³ to ≤100000 node points/m³.

Suitable materials for the body are in particular elastomers such as polyurethane elastomers. Elastomers may generally be thermosetting or thermoplastic materials or else mixtures thereof. In the body it is preferable to employ materials which at a density of ≥1 kg/l have a hardness by Shore A measurement (DIN ISO 7619-1) of ≥40 Shore A and ≤100 Shore A, preferably ≥50 Shore A and ≤98 Shore A, more preferably ≥60 Shore A and ≤95 Shore A. Thermoplastic polyurethane elastomers are preferred.

The material of the body in a first region of the body may be different from the material in a second region of the body. Different materials with correspondingly different mechanical properties may preferably be used to produce the body according to the invention in a melt layering process with printing heads for more than one material. Not only two different materials from one substance class such as for example two thermoplastic polyurethane elastomers having different elastic moduli but also two materials from different substance classes are suitable.

In a further preferred embodiment the body is at least partially formed from a polymeric material selected from the group of: thermosetting polyurethanes, epoxides, polyacrylates, polyurethane acrylates, thermoplastic polyamides, thermoplastic polyesters, polyvinyl acetate, polystyrene, polyethylene, polypropylene, polyoxymethylene, polyvinyl chloride, polyurethanes, polyacrylates, polyether ether kethones, polyetherimides, olefin-based thermoplastic elastomers (TPO), styrene block copolymers (TPS), urethane-based thermoplastic elastomers (TPU), olefin-based crosslinked thermoplastic elastomers (TPV), polyvinyl chloride-based thermoplastic elastomers (PVC), silicone-based thermoplastic elastomers, sulfur- or oxygen-crosslinked elastomer/rubber raw materials and a combination of at least two of the aforementioned materials.

In a further preferred embodiment, the polymeric material is a thermoplastic elastomer and has a melting range (DSC, differential scanning calorimetry; second heating at a heating rate of 5 K/min) of ≥20° C. to ≤240° C. (preferably ≥40° C. to ≤240° C., more preferably ≥70° C. to ≤240° C.), a Shore hardness according to DIN ISO 7619-1 of ≥40 A to ≤80 Shore D (preferably ≥50 Shore A to ≤60 Shore D, more preferably ≥60 Shore A to ≤98 Shore A) and a melt volume rate (MVR) according to ISO 1133 (240° C., 10 kg) of ≥25 to ≤250 (preferably ≥30 to ≤180, more preferably ≥40 to ≤150) cm³/10 min.

In this DSC analysis, the material is subjected to the following temperature cycle: 1 minute at minus 60° C., then heating to 250° C. at 5 kelvin/minute, then cooling to minus 60° C. at 5 kelvin/minute, then 1 minute at minus 60° C., then heating to 250° C. at 5 kelvin/minute.

In a further preferred embodiment, the elastomer is a thermoplastic elastomer and has a melting range (DSC, differential scanning calorimetry; second heating at a heating rate of 5 K/min) of ≥20° C. to ≤240° C. (preferably ≥40° C. to ≤240° C., more preferably ≥70° C. to ≤240° C.), a Shore hardness according to DIN ISO 7619-1 of ≥40 A to ≤80 D (preferably ≥50 Shore A to ≤60 Shore D, more preferably ≥60 Shore A to ≤98 Shore A); a melt volume rate (MVR) at a temperature T according to ISO 1133 (10 kg) of 5 to 15 (preferably ≥6 to ≤12, more preferably ≥7 to ≤10) cm³/10 min and exhibits a change in the melt volume rate (10 kg) at an increase of this temperature T by 20° C. of ≤90 (preferably ≤70, more preferably ≤50) cm³/10 min.

In this DSC analysis too, the material is subjected to the following temperature cycle: 1 minute at minus 60° C., then heating to 250° C. at 5 kelvin/minute, then cooling to minus 60° C. at 5 kelvin/minute, then 1 minute at minus 60° C., then heating to 250° C. at 5 kelvin/minute.

This thermoplastic elastomer, preferably a thermoplastic polyurethane elastomer, preferably has uniform melting characteristics. Melting characteristics are determined via the change in MVR (melt volume rate) according to ISO 1133 with a preheating time of 5 minutes and 10 kg as a function of temperature. Melting characteristics are considered to be “uniform” when the MVR at a starting temperature Tₓ has a starting value of 5 to 15 cm³/10 min and increases by not more than 90 cm³/10 min as a result of an increase in temperature by 20° C. to Tₓ₊₂₀.

In a further preferred embodiment, the polymeric material is a thermoplastic polyurethane elastomer obtainable from the reaction of the following components:

a) at least one organic diisocyanate
b) at least one compound having groups reactive toward isocyanate groups and having a number-average molecular weight (Mₐ) of ≥500 g/mol to ≤6000 g/mol and a number-average functionality of the totality of the components covered by b) of ≥1.8 to ≤3.0
c) at least one chain extender having a molecular weight (Mn) of 60-450 g/mol and a number-average functionality of the totality of the chain extenders covered by c) of 1.8 to 2.5.

For synthesis of this thermoplastic polyurethane elastomer (TPU), specific examples of isocyanate component covered by a) include: aliphatic diisocyanates such as ethylene diisocyanate, tetramethylene 1,4-diisocyanate, pentamethylene 1,5-diisocyanate, hexamethylene 1,6-diisocyanate, dodecane 1,12-diisocyanate, cycloaliphatic diisocyanates such as isophorone diisocyanate, cyclohexane 1,4-diisocyanate, 1-methylcyclohexane 2,4-diisocyanate and 1-methylcyclohexane 2,6-diisocyanate and the corresponding isomer mixtures, dicyclohexylmethane 4,4′-diisocyanate, dicyclohexylmethane 2,4′-diisocyanate and dicyclohexylmethane 2,2′-diisocyanate and the corresponding isomer mixtures, and also aromatic diisocyanates such as tolylene 2,4-diisocyanate, mixtures of tolylene 2,4-diisocyanate and tolylene 2,6-diisocyanate, diphenylmethane 4,4′-diisocyanate, diphenylmethane 2,4′-diisocyanate and diphenylmethane 2,2′-diisocyanate, mixtures of diphenylmethane 2,4′-diisocyanate and diphenylmethane 4,4′-diisocyanate, urethane-modified liquid diphenylmethane 4,4′-diisocyanates or diphenylmethane 2,4′-diisocyanates, 4,4′-diisocyanato-1,2-diphenylethane and naphthylene 1,5-diisocyanate. Preference is given to using hexamethylene 1,6-diisocyanate, cyclohexane 1,4-diisocyanate, isophorone diisocyanate, dicyclohexylmethane diisocyanate, diphenylmethane diisocyanate isomer mixtures having a diphenylmethane 4,4′-diisocyanate content of more than 96% by weight and especially diphenylmethane 4,4′-diisocyanate and naphthylene 1,5-diisocyanate. These diisocyanates can be used individually or in the form of mixtures with one another. They may also be used together with up to 15 mol % (based on total diisocyanate) of a polyisocyanate, but the maximum amount of polyisocyanate that may be added is such as to result in a product that is still thermoplastically processible. Examples of polyisocyanates are triphenylmethane 4,4′,4″-triisocyanate and polyphenylpolymethylene polyisocyanates.

Examples of longer-chain isocyanate-reactive compounds covered by b) include those having on average at least 1.8 to 3.0 Zerewitinoff-active hydrogen atoms and a number-average molecular weight of 500 to 10 000 g/mol. These include, in addition to compounds having amino groups, thiol groups or carboxyl groups, especially compounds having two to three, preferably two, hydroxyl groups, specifically those having number-average molecular weights Mn of 500 to 6000 g/mol, particularly preferably those having a number-average molecular weight Mn of 600 to 4000 g/mol, for example hydroxyl group ˜containing polyester polyols, polyether polyols, polycarbonate polyols and polyester polyamides. Suitable polyester diols may be produced by reacting one or more alkylene oxides having 2 to 4 carbon atoms in the alkylene radical with a starter molecule containing two active hydrogen atoms in bonded form. Examples of alkylene oxides include: ethylene oxide, 1,2-propylene oxide, epichlorohydrin and 1,2-butylene oxide and 2,3-butylene oxide. Preference is given to using ethylene oxide, propylene oxide and mixtures of 1,2-propylene oxide and ethylene oxide. The alkylene oxides may be used individually, in alternating succession or as mixtures. Contemplated starter molecules include for example water, amino alcohols such as N-alkyldiethanolamines, for example N-methyldiethanolamine, and diols such as ethylene glycol, 1,3-propylene glycol, butane-1,4-diol, pentane-1,5-diol and hexane-1,6-diol. It is optionally also possible to employ mixtures of starter molecules. Suitable polyether diols further include the hydroxyl group ˜containing polymerization products of tetrahydrofuran. It is also possible to use trifunctional polyethers in proportions of 0% to 30% by weight, based on the bifunctional polyether diols, but at most in such an amount as to result in a product that is still thermoplastically processible. The essentially linear polyether diols preferably have number-average molecular weights n of 500 to 6000 g/mol. They may be used either individually or in the form of mixtures with one another.

Suitable polyester diols may be produced, for example, from dicarboxylic acids having 2 to 12 carbon atoms, preferably 4 to 6 carbon atoms, and polyhydric alcohols. Contemplated dicarboxylic acids include for example: aliphatic dicarboxylic acids such as succinic acid, glutaric acid, adipic acid, suberic acid, azelaic acid and sebacic acid, or aromatic dicarboxylic acids such as phthalic acid, isophthalic acid and terephthalic acid. The dicarboxylic acids may be used individually or as mixtures, for example in the form of a succinic, glutaric and adipic acid mixture. To produce the polyester diols, it may in some cases be advantageous to employ not the dicarboxylic acids but rather the corresponding dicarboxylic acid derivatives such as carboxylic diesters having 1 to 4 carbon atoms in the alcohol radical, carboxylic anhydrides or carbonyl chlorides. Examples of polyhydric alcohols include glycols having 2 to 10, preferably 2 to 6, carbon atoms, for example ethylene glycol, diethylene glycol, 1,4-butanediol, 1,5-pentanediol, 1,6-hexanediol, 1,10-decanediol, 2,2-dimethyl-1,3-propanediol, 1,3-propanediol or dipropylene glycol. Depending on the desired properties, the polyhydric alcohols may be used alone or in admixture with one another. Also suitable are esters of carbonic acid with the recited diols, especially those having 4 to 6 carbon atoms, such as butane-1,4-diol or hexane-1,6-diol, condensation products of ω-hydroxycarboxylic acids such as ω-hydroxycaproic acid, or polymerization products of lactones, for example optionally substituted ω-caprolactone. Preferably employed polyester diols are ethanediol polyadipates, butane-1,4-diol polyadipates, ethanediol butane-1,4-diol polyadipates, hexane-1,6-diol neopentyl glycol polyadipates, hexane-1,6-diol butane-1,4-diol polyadipates, and polycaprolactones. The polyester diols preferably have number-average molecular weights Mn of 450 to 6000 g/mol and can be employed individually or in the form of mixtures with one another.

The chain extenders covered by c) have on average 1.8 to 3.0 Zerewitinoff-active hydrogen atoms and have a molecular weight of 60 to 450 g/mol. This is to be understood as meaning compounds having amino groups, thiol groups or carboxyl groups, but also those having two to three, preferably two, hydroxyl groups.

Preferably employed chain extenders are aliphatic diols having 2 to 14 carbon atoms, for example ethanediol, propane-1,2-diol, propane-1,3-diol, butane-1,4-diol, butane-2,3-diol, pentane-1,5-diol, hexane-1,6-diol, diethylene glycol and dipropylene glycol. Also suitable, however, are diesters of terephthalic acid with glycols having 2 to 4 carbon atoms, for example terephthalic acid bis-ethylene glycol or terephthalic acid bis-butane-1,4-diol, hydroxyalkylene ethers of hydroquinone, for example 1,4-di(b-hydroxyethyl)hydroquinone, ethoxylated bisphenols, for example 1,4-di(b-hydroxyethyl)bisphenol A, (cyclo)aliphatic diamines, such as isophoronediamine, ethylenediamine, propylene-1,2-diamine, propylene-1,3-diamine, N-methylpropylene-1,3-diamine, N,N′-dimethylethylenediamine and aromatic diamines such as tolylene-2,4-diamine, tolylene-2,6-diamine, 3,5-diethyltolylene-2,4-diamine or 3,5-diethyltolylene-2,6-diamine or primary mono-, di-, tri- or tetraalkyl-substituted 4,4′-diaminodiphenylmethanes. Chain extenders used with particular preference are ethanediol, butane-1,4-diol, hexane-1,6-diol, 1,4-di(β-hydroxyethyl)hydroquinone or 1,4-di(β-hydroxyethyl)bisphenol A. Mixtures of the abovementioned chain extenders may also be employed.

In addition, relatively small amounts of triols may also be added.

Compounds monofunctional toward isocyanates may be employed as so-called chain terminators under f) in proportions of up to 2% by weight based on TPU. Suitable examples include monoamines such as butyl- and dibutylamine, octylamine, stearylamine, N-methylstearylamine, pyrrolidine, piperidine or cyclohexylamine, monoalcohols such as butanol, 2-ethylhexanol, octanol, dodecanol, stearyl alcohol, the various amyl alcohols, cyclohexanol and ethylene glycol monomethyl ether.

The isocyanate-reactive substances should preferably be chosen such that their number-average functionality does not significantly exceed two if thermoplastically processible polyurethane elastomers are to be produced. If higher-functional compounds are used, the overall functionality should accordingly be lowered using compounds having a functionality of <2.

The relative amounts of isocyanate groups and isocyanate-reactive groups are preferably chosen such that the ratio is 0.9:1 to 1.2:1, preferably 0.95:1 to 1.1:1.

The thermoplastic polyurethane elastomers used in accordance with the invention may comprise as auxiliary and/or additive substances up to a maximum of 20% by weight, based on the total amount of TPU, of customary auxiliary and additive substances. Typical auxiliary and additive substances are catalysts, antiblocking agents, inhibitors, pigments, colorants, flame retardants, stabilizers against ageing and weathering effects and against hydrolysis, light, heat and discoloration, plasticizers, lubricants and demolding agents, fungistatic and bacteriostatic substances, reinforcers and inorganic and/or organic fillers and mixtures thereof.

Examples of additive substances are lubricants, such as fatty acid esters, metal soaps thereof, fatty acid amides, fatty acid ester amides and silicone compounds, and reinforcers, for example fibrous reinforcers, such as inorganic fibers, which are produced according to the prior art and may also be treated with a size. Further information about the recited auxiliary and additive substances may be found in the specialist literature, for example in the monograph by J. H. Saunders and K. C. Frisch “High Polymers”, Volume XVI, Polyurethane, Part 1 and 2, Interscience Publishers 1962/1964, in “Taschenbuch für Kunststoff-Additive” by R. Gächter and H. Müller (Hauser Verlag Munich 1990) or in DE-A 29 01 774.

Suitable catalysts are the customary tertiary amines known from the prior art, for example triethylamine, dimethylcyclohexylamine, N-methylmorpholine, N,N′-dimethylpiperazine, 2-(dimethylaminoethoxy)ethanol, diazabicyclo[2.2.2]octane and the like and also in particular organic metal compounds such as titanate esters, iron compounds or tin compounds such as tin diacetate, tin dioctoate, tin dilaurate or the dialkyltin salts of aliphatic carboxylic acids such as dibutyltin diacetate or dibutyltin dilaurate or the like. Preferred catalysts are organic metal compounds, in particular titanate esters, iron compounds and tin compounds. The total amount of catalysts in the TPUs employed is generally about 0% to 5% by weight, preferably 0% to 2% by weight, based on the total amount of TPU.

Thermosetting polyurethane elastomers suitable according to the invention may include for example 2-component cast elastomers. These are obtainable by known methods from a reaction mixture comprising:

a) at least one organic polyisocyanate
b) at least one compound comprising isocyanate-reactive groups and having a number-average molecular weight (Mₙ) of ≥500 g/mol to ≤6000 g/mol and a number-average functionality of the entirety of the components covered by b) of ≥2.1
c) optionally at least one chain extender having a molecular weight (Mn) of 60-450 g/mol.

For details of polyisocyanates and NCO-reactive compounds reference is made to what is stated above.

In a further preferred embodiment the polymeric material is a thermoplastic elastomer and has a melting range (DSC, differential scanning calorimetry; 2nd heating at a heating rate of 5 K/min) of ≥20° C. to ≤100° C. and a magnitude of complex viscosity |η*| (determined by viscometry measurement in the melt with a cone/plate oscillation shear viscometer at 100° C. and a shear rate of 1/s) of ≥10 Pas to ≤1 000 000 Pas.

This thermoplastic elastomer has a melting range of ≥20° C. to ≤100° C., preferably of ≥25° C. to ≤90° C. and more preferably of ≥30° C. to ≤80° C. In the DSC analysis for determination of the melting range, the material is subjected to the following temperature cycle: 1 minute at −60° C., then heating to 200° C. at 5 kelvin/minute, then cooling to −60° C. at 5 kelvin/minute, then 1 minute at −60° C., then heating to 200° C. at 5 kelvin/minute.

It is possible that the temperature interval between the start of the melting operation and the end of the melting operation as determinable according to the above DSC protocol is ≤20° C., preferably ≤10° C. and more preferably ≤5° C.

This thermoplastic elastomer further has a magnitude of complex viscosity |η*| (determined by viscometry measurement in the melt with a plate/plate oscillation viscometer according to ISO 6721-10 at 100° C. and a shear rate of 1/s) of ≥10 Pas to ≤1 000 000 Pas. |η*| is preferably ≥100 Pas to ≤500 000 Pas, more preferably ≥1000 Pas to ≤200 000 Pas.

The magnitude of complex viscosity |η*| describes the ratio of the viscoelastic moduli G′ (storage modulus) and G″ (loss modulus) to the excitation frequency a in a dynamic-mechanical material analysis:

$$\vert {η}^{*} \vert = \sqrt{[ {( \frac{{G}^{′}}{ω} )}^{2} + {( \frac{{G}^{″}}{ω} )}^{2} ]} = \frac{\vert {G}^{*} \vert}{ω}$$

This thermoplastic elastomer is preferably a thermoplastic polyurethane elastomer.

In a further preferred embodiment the elastomer is a thermoplastic polyurethane elastomer obtainable from the reaction of a polyisocyanate component and a polyol component, wherein the polyol component comprises a polyesterpolyol having a no-flow point (ASTM D5985) of ≥25° C.

Optionally also employable as chain extenders in the reaction to afford this polyurethane are diols in the molecular weight range from ≥62 to ≤600 g/mol.

This polyisocyanate component may comprise a symmetric polyisocyanate and/or an asymmetric polyisocyanate. Examples of symmetric polyisocyanates are 4,4′-MDI and HDI.

In the case of asymmetric polyisocyanates the steric environment of one NCO group in the molecule is different from the steric environment of a further NCO group. One isocyanate group then reacts more quickly with isocyanate-reactive groups, for example OH groups, while the remaining isocyanate group is less reactive. One consequence of the asymmetric structure of the polyisocyanate is that the polyurethanes formed with these polyisocyanates also have a less linear structure.

Examples of suitable asymmetric polyisocyanates are 2,2,4-trimethylhexamethylene diisocyanate, ethylethylene diisocyanate, asymmetric isomers of dicyclohexylmethane diisocyanate (H₁₂-MDI), asymmetric isomers of 1,4-diisocyanatocyclohexane, asymmetric isomers of 1,3-diisocyanatocyclohexane, asymmetric isomers of 1,2-diisocyanatocyclohexane, asymmetric isomers of 1,3-diisocyanatocyclopentane, asymmetric isomers of 1,2-diisocyanatocyclopentane, asymmetric isomers of 1,2-diisocyanatocyclobutane, 1-isocyanatomethyl-3-isocyanato-1,5,5-trimethylcyclohexane (isophorone diisocyanate, IPDI), 1-methyl-2,4-diisocyanatocyclohexane, 1,6-diisocyanato-2,2,4-trimethylhexane, 1,6-diisocyanato-2,4,4-trimethylhexane, 5-isocyanato-1-(3-isocyanatoprop-1-yl)-1,3,3-trimethylcyclohexane, 5-isocyanato-1-(4-isocyanatobut-1-yl)-1,3,3-trimethylcyclohexane, 1-isocyanato-2-(3-isocyanatoprop-1-yl)cyclohexane, 1-isocyanato-2-(2-isocyanatoeth-1-yl)cyclohexane, 2-heptyl-3,4-bis(9-isocyanatononyl)-1-pentylcyclohexane, norbornane diisocyanatomethyl, diphenylmethane 2,4′-diisocyanate (MDI), tolylene 2,4- and 2,6-diisocyanate (TDI), and derivatives of the recited diisocyanates, especially dimerized or trimerized types.

Preferred as the polyisocyanate component are 4,4′-MDI or a mixture comprising IPDI and HDI.

This polyol component comprises a polyester polyol having a no-flow point (ASTM D5985) of ≥25° C., preferably ≥35° C., more preferably ≥35° C. to ≤55° C. To determine the no-flow point a test vessel containing the sample is set into slow rotation (0.1 rpm). A flexibly mounted measuring head is immersed in the sample and, on attainment of the no-flow point, is moved away from its position as a result of the abrupt increase in viscosity; the resulting tipping motion triggers a sensor.

Examples of polyesterpolyols which can have such a no-flow point are reaction products of phthalic acid, phthalic anhydride or symmetric α,ω-C₄- to C₁₀-dicarboxylic acids with one or more C₂- to C₁₀-diols. They preferably have a number-average molecular weight Mₙ of ≥400 g/mol to ≤6000 g/mol. Suitable diols are especially monoethylene glycol, butane-1,4-diol, hexane-1,6-diol and neopentyl glycol.

Preferred polyesterpolyols are specified hereinbelow by reporting their acid and diol components: adipic acid+monoethylene glycol; adipic acid+monoethylene glycol+butane-1,4-diol; adipic acid+butane-1,4-diol; adipic acid+hexane-1,6-diol+neopentyl glycol; adipic acid+hexane-1,6-diol; adipic acid+butane-1,4-diol+hexane-1,6-diol; phthalic acid(anhydride)+monoethylene glycol+trimethylolpropane; phthalic acid(anhydride)+monoethylene glycol. Preferred polyurethanes are obtained from a mixture comprising IPDI and HDI as the polyisocyanate component and a polyol component comprising an abovementioned preferred polyesterpolyol. Particularly preferred for constructing the polyurethanes is the combination of a mixture containing IPDI and HDI as the polyisocyanate component with a polyesterpolyol formed from adipic acid+butane-1,4-diol+hexane-1,6-diol.

It is further preferred when these polyester polyols have an OH number (DIN 53240) of ≥25 to ≤170 mg KOH/g and/or a viscosity (75° C., DIN 51550) of ≥50 to ≤5000 mPas.

One example is a polyurethane obtainable from the reaction of a polyisocyanate component and a polyol component, wherein the polyisocyanate component comprises an HDI and IPDI and wherein the polyol component comprises a polyesterpolyol which is obtainable from the reaction of a reaction mixture comprising adipic acid and also hexane-1,6-diol and butane-1,4-diol with a molar ratio of these diols of ≥1:4 to ≤4:1 and which has a number-average molecular weight Mₙ (GPC, against polystyrene standards) of ≥4000 g/mol to ≤6000 g/mol. Such a polyurethane may have a magnitude of complex viscosity |η*| (determined by viscometry measurement in the melt with a plate/plate oscillation viscometer according to ISO 6721-10 at 100° C. and a shear rate of 1/s) of ≥4000 Pas to ≤160 000 Pas.

A further example of a suitable polyurethane is:

1. Substantially linear polyester polyurethanes having terminal hydroxyl groups as described in EP 0192946 A1, produced by reaction of
a) polyester dials having a molecular weight above 600 and optionally
b) diols in the molecular weight range from 62 to 600 g/mol as chain extenders with
c) aliphatic diisocyanates,
while observing an equivalent ratio of hydroxyl groups of components a) and b) to isocyanate groups of component c) of 1:0.9 to 1:0.999, wherein component a) consists to an extent of at least 80% by weight of polyester diols in the molecular weight range of 4000 to 6000 based on (i) adipic acid and (ii) mixtures of 1,4-dihydroxybutane and 1,6-dihydroxyhexane in a molar ratio of the diols of 4:1 to 1:4.

In the polyester polyurethanes recited under 1, it is preferable when component a) consists to an extent of 100% of a polyester diol in the molecular weight range of 4000 to 6000 wherein the production thereof has employed as the diol mixture a mixture of 1,4-dihydroxybutane and 1,6-dihydroxyhexane in a molar ratio of 7:3 to 1:2.

In the polyester polyurethanes recited under 1, it is further preferable when component c) comprises IPDI and also HDI.

In the polyester polyurethanes recited under 1. it is further preferable when the production thereof comprised co-use as component b) of alkanediols selected from the group consisting of 1,2-dihydroxyethane, 1,3-dihydroxypropane, 1,4-dihydroxybutane, 1,5-dihydroxypentane, 1,6-dihydroxyhexane and any desired mixtures of these diols in an amount of up to 200 hydroxyl equivalent percent based on component a).

It is further possible that after heating to 100° C. and cooling to 20° C. at a cooling rate of 4° C./min over a temperature interval from 25° C. to 40° C. for ≥1 minute (preferably ≥1 minute to ≤30 minutes, more preferably ≥10 minutes to ≤15 minutes) the thermoplastic elastomer has a storage modulus G′ (determined at the respectively prevailing temperature with a plate/plate oscillation viscometer according to ISO 6721-10 at a shear rate of 1/s) of ≥100 kPa to ≤1 MPa and after cooling to 20° C. and storage for 20 minutes has a storage modulus G′ (determined at 20° C. with a plate/plate oscillation viscometer according to ISO 6721-10 at a shear rate of 1/s) of ≥10 MPa.

In a further preferred embodiment the foam is at least partially formed from a polyurethane foam. Suitable polyurethane foams are obtainable by methods known to those skilled in the art. Thus the reaction mixture may contain abovementioned polyisocyanates and polyols and additionally chemical and/or physical blowing agents.

In a further preferred embodiment the composite article has a compression set after 10% compression (DIN ISO 815-1) of ≤2%, preferably ≤1%, more preferably ≤0.5%.

In a further preferred embodiment the polymeric material is a crosslinked polyacrylate crosslinked by means of free-radical crosslinking proceeding from liquid starting, products in the presence of photoinitiators by the action of actinic radiation.

In a further preferred embodiment in the body the struts have an average length of ≥200 μm to ≤200 mm, the struts have an average thickness of ≥100 μm to ≤5 mm and the body has in at least one spatial direction a compressive strength (40% compression, DIN EN ISO 3386-1:2010-09) of ≥10 to ≤1000 kPa.

The struts have an average length of preferably ≥500 μm to ≤50 mm and more preferably ≥750 μm to ≤20 mm. Furthermore the struts have an average thickness of preferably ≥500 μm to ≤2.5 mm and more preferably ≥750 μm to ≤1 mm. If over the course of an individual strut the thickness thereof changes, which may quite possibly be intentional for construction purposes, the average thickness is initially determined for the individual strut and then this value is used for the calculation of the average thickness of the entirety of the struts. In at least one spatial direction the body has a compressive strength (40% compression, DIN EN ISO 3386-1:2010-09) of preferably ≥20 to ≤70 kPa and more preferably ≥30 to ≤40 kPa.

In a further preferred embodiment in the body the node points are distributed in a periodically repeating manner in at least a portion of the volume of the body. If the node points are distributed in a periodically repeating manner in a volume this may be described using the terms of crystallography. The node points may be arranged according to the 14 Bravais lattices: simple cubic (sc), body-centered cubic (bcc), face-centered cubic (fcc), simple tetragonal, body-centered, tetragonal, simple orthorhombic, base-centered orthorhombic, body-centered orthorhombic, face-centered orthorhombic, simple hexagonal, rhombohedral, simple monoclinic, base-centered monoclinic and triclinic. The cubic lattices sc, fcc and bcc are preferred.

In a further preferred embodiment the space in the body is in the form of interpenetrating first, second and third channel groups, wherein a multiplicity of individual channels within each respective channel group run parallel to one another and the first channel group, the second channel group and the third channel group extend in different spatial directions.

In a further preferred embodiment the average minimum angle between adjacent struts in the body is ≥30° to ≤140°, preferably ≥45° to ≤120°, more preferably ≥50° to ≤100°. This angle is always determined when the body is in an unstressed state. Adjacent struts are struts of the kind having a common node point. The minimum angle between two adjacent struts is to be understood as meaning that when observing a strut having a plurality of adjacent struts forming different angles with the observed strut the smallest of these angles is selected. One example thereof, expressed in chemical terminology, is an octahedrally coordinated node point. Emanating from this node point are six struts, opposite struts forming an angle of 180° to one another and struts directly adjacent in a plane forming an angle of 90° to one another. In this example the minimum angle between adjacent struts would be 90°.

In a further preferred embodiment in the body the spatial density of the node points in a first region of the body is different from the spatial density of the node points in a second region of the body. In terms of geometry, the center of the node points is being considered here. The spatial density of the node points in the first region of the body may be for example ≥1 node paints/cm³ to ≤200 node points/cm³, preferably ≥2 node points/cm³ to ≤100 node paints/cm³, more preferably ≥3 node points/cm³ to ≤60 node points/Cm³. With the proviso that it is different from the density in the first region the spatial density of the node points in the second region of the body may be for example ≥2 node points/cm³ to ≤200 node points/cm³, preferably ≥5 node points/cm³ to ≤100 node points/cm³, more preferably ≥10 node points/cm³ to ≤60 node points/cm³.

It is also possible to express the differences in spatial density in that the spatial density of the node points in a first region of the body is ≥1.1 times to ≤10 times, preferably ≥1.5 times to ≤7 times, more preferably ≥2 times to ≤5 times, the spatial density of the node points in a second region of the body.

A specific example would be a body having a density of the node points in a first region of ≥39 node points/cm³ to ≤41 node points/cm³ and a density of the node points in a second region of ≥19 node points/cm³ to ≤21 node points/cm³.

The present invention further relates to the use of a composite article according to the invention as a supporting element and/or as a mounting element. For the use of the composite article according to the invention as a cushion, mattress and the like it may be advantageous when it has regions of different mechanical properties and especially regions having different compression hardnesses and optionally different tan δ values. Thus, a mattress may be configured in the region of the shoulder areas to allow a person lying on his/her side to sink lower than the rest of the person's body, in order that the person overall still lies straight with respect to the spinal column.

The present invention further provides a process for producing a composite article according to the invention comprising the steps of:
(I) producing a body by means of an additive manufacturing process;
II) contacting the body with a foam-forming composition, wherein the composition at least partially penetrates into the interior of the body;
III) forming a foam to obtain the composite article.

The present invention further provides a process for producing a composite article according to the invention comprising the steps of:
I′) producing a body by means of an additive manufacturing process, wherein the body comprises a spatial network of node points joined to one another by struts and a space present between the struts;
II′) contacting the body with a reaction mixture which reacts to afford a polymer foam, wherein the reaction mixture at least partially penetrates into the space between the struts of the body;
III′) reacting the reaction mixture to afford a polymer foam to obtain the composite article, wherein the body is at least partially formed from a polymeric material different from the polymer foam.

According to step I) or I′) the body is produced by means of an additive manufacturing process. An additive manufacturing process allows for individualized adaptation of for example the damping properties of a body. Individualized is here to be understood as meaning not only that it is possible to produce one-off articles but also that it is possible for example to adjust the damping properties of a support or mounting element at different points as desired and as part of the process. It is thus possible, for example, for a mattress to be created individually for a customer according to anatomical requirements or needs. In order for example to achieve an optimal pressure distribution when lying on the mattress, it is possible initially to record a pressure profile of the body on a sensor surface and to use the thus-obtained data for individualization of the mattress. The data are then sent to the additive manufacturing process in a manner known per se.

The process may be selected, for example, from melt layering (fused filament fabrication, FFF, or fused deposition modelling, FDM), inkjet printing, photopolymer jetting, stereo lithography, selective laser sintering, digital light processing-based additive manufacturing system, continuous liquid interface production, selective laser melting, binder jetting-based additive manufacturing, multijet fusion-based additive manufacturing, high speed sintering process and laminated object modelling. It is preferable when the additive manufacturing process is a sintering process or a melt layering process.

In the context of the present invention, sintering processes are processes which in particular utilize thermoplastic powders to construct articles in layerwise fashion. In this case a so-called coater applies thin layers of powder which are then subsequently subjected to selective melting by means of an energy source. The surrounding powder supports the component geometry in this case. Complex geometries can thus be manufactured more economically than in the EOM method. Moreover, different articles may be arranged or manufactured in a tightly packed manner in the so-called powder bed. Owing to these advantages, powder-based additive manufacturing processes are among the most economically viable additive manufacturing processes on the market. They are therefore used predominantly by industrial users. Examples of powder-based additive manufacturing processes include so-called selective laser sintering (SLS) or high-speed sintering (HSS). They differ from one another in the method for introducing into the plastic the energy for the selective melting. In the laser sintering process energy input is effected via a deflected laser beam. In so-called high-speed sintering (HSS) processes energy input is effected via infrared (IR) sources in combination with an IR absorber selectively printed into the powder bed. So-called selective heat sintering (SHS) utilizes the printing unit of a conventional thermal printer to selectively melt thermoplastic powders. Selective laser sintering processes (SLS′) are preferred.

The term “melt layering process” refers to a manufacturing process from the field of additive manufacturing, with which a workpiece is formed in layerwise fashion, for example from a meltable plastic. The plastic may be used with or without further additions such as fibers. Machines for FFF belong to the machine class of 3D printers. This process is based on the liquefaction of a wire-shaped plastics or wax material by heating. The material solidifies in the course of final cooling. Material application is effected by extrusion with a heating nozzle which is freely movable in relation to a manufacturing plane. It is possible here either for the manufacturing plane to be fixed and for the nozzle to be freely movable or for a nozzle to be fixed and a substrate table (with a manufacturing plane) to be movable, or for both elements, the nozzle and manufacturing plane, to be movable. The speed with which substrate and nozzle are movable with respect to one another is preferably within a range from 1 to 200 mm/s. The layer thickness is within a range from 0.025 and 1.25 mm depending on the application and the exit diameter of the material jet (nozzle outlet diameter) from the nozzle is typically at least 0.05 mm.

In layerwise modelling the individual layers thus join to form a complex part. The construction of a body is customarily effected by repeatedly tracing a working plane line by line (forming a layer) and then moving the working plane upward in a “stacking” manner (forming at least one further layer atop the first layer) so as to form a shape in layerwise fashion. The exit temperature of the mixtures of material from the nozzle may be 80° C. to 420° C. for example. It is additionally possible to heat the substrate table, for example to 20° C. to 250° C. This can prevent excessively fast cooling of the applied layer so that a further layer applied thereupon is sufficiently joined to the first layer.

In step II) of the process contacting of the body is effected with a foam-forming composition, wherein the composition at least partially penetrates into the interior of the body. The forming of a foam to obtain the composite article may then be effected according to step III).

In step II′) of the process the body is contacted with a reaction mixture which reacts to afford a polymer foam. It is preferable when a reaction mixture which reacts to afford a polyurethane foam is concerned, particularly preferably in combination with a body whose material contains a polyurethane, polymer. The contacting is effected such that the reaction mixture at least partially penetrates into the space between the struts of the body. The reaction mixture can then react to afford the polymer foam according to step III′). The foam may be open-celled or closed-celled. The contacting in step II) may be carried out in closed or open molds. The foam-covered body may also form part of the delimiting shape of the foam. Post-processing of the foam-covered products by targeted removal of excess foam or of parts of the body, such as for example supporting structures, is likewise conceivable.

The contacting in step II′) may be carried out in closed or open molds. The foam-covered body may also form part of the delimiting shape of the foam. Post-processing of the foam-covered products by targeted removal of excess foam or of parts of the body, such as for example supporting structures, is likewise conceivable.

The process according to the invention comprising the steps I′), II′) and III′) also provides for at least partially forming the body from a polymeric material different to the polymer foam. The difference may be based on physical properties (for example a different density) and/or on chemical properties (for example chemically distinct materials).

The present invention is more particularly elucidated using the figures which follow and with reference to preferred embodiments without, however, being limited thereto. In the drawings:

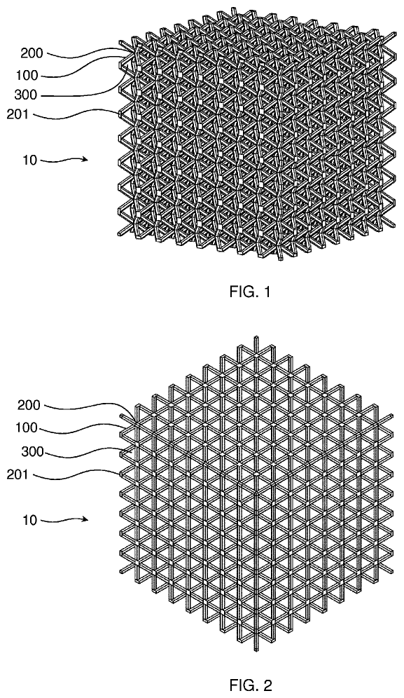

FIG. 1 shows a body in a first view

FIG. 2 shows the body from FIG. 1 in another view

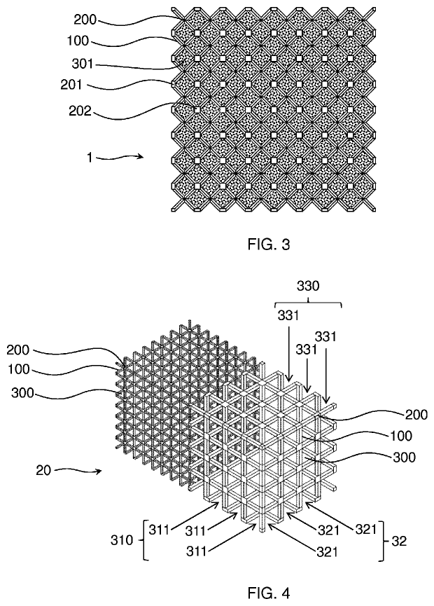

FIG. 3 shows a composite article according to the invention

FIG. 4 shows a further body

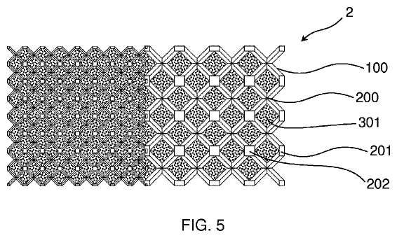

FIG. 5 shows a further composite article according to the invention

FIG. 1 shows a body 10 such as is employable for the production of a composite article according to the invention in a perspective view with a spatial network of node points 200 joined to one another by struts 100. Present between the struts 100 is the space 300. Present at the edges of the body 10 are truncated node points 201 whose struts project only into the interior of the body 10. FIG. 2 shows the same body 10 in an isometric view.

The node points 200 may be uniformly distributed in the body 10 in at least a portion of the volume thereof. Likewise said node points 200 may be nonuniformly distributed in at least a portion of the volume thereof. It is also possible for the body 10 to comprise one or more subvolumes in which the node points 200 are uniformly distributed and to comprise one or more subvolumes in which the node points 200 are nonuniformly distributed.

Depending on the construction of the network of struts 100 and node points 200 in the body 10 certain mechanical properties may also be a function of the spatial direction in which they are determined on the body. This is the case for example for the body 10 shown in FIGS. 1 and 2. Along the spatial directions corresponding to the base vectors of the elementary cell the compressive strength and the tan δ value in particular may be different than, for example, along a spatial direction which includes all three base vectors as components.

The space 300 may account for ≥50% to ≤99%, preferably ≥55% to ≤95%, more preferably ≥60% to ≤90%, of the volume of the body 10. When the density of the starting material for the body and the density of the body itself are known this parameter is easily determinable.

It is preferable when the node points 200 are distributed in a periodically repeating manner in at least a portion of the volume of the body 10. When the node points 200 are distributed in a periodically repeating manner in a volume this may be described using the terms of crystallography. The node points may be arranged according to the 14 Bravais lattices: simple cubic (Sc), body-centered cubic (bcc), face-centered cubic (fcc), simple tetragonal, body-centered tetragonal, simple orthorhombic, base-centered orthorhombic, body-centered orthorhombic, face-centered orthorhombic, simple hexagonal, rhombohedral, simple monoclinic, base-centered monoclinic and triclinic. The cubic lattices sc, fcc and bcc are preferred.

Persisting with the crystallographic perspective the number of struts 100 by means of which one node point 200 is connected to other node points may be regarded as the coordination number of the node point 200. The average number of struts 100 that emanate from the node points 200 may be ≥4 to ≤12 but it is also possible to achieve coordination numbers that are unusual or impossible in crystallography. For the determination of the coordination numbers, truncated node points on the outer face of the body, as labelled with reference numerals 201 in FIG. 1, are disregarded.

The presence of unusual coordination numbers or coordination numbers that are impossible in crystallography may be achieved in particular when the body is produced by means of additive manufacturing techniques. It is likewise possible for a first group of node points 200 to have a first average number of struts 100 and a second group of node points to have a second average number of struts 100, wherein the first average number is different from the second average number.

In the body 10 shown in FIGS. 1 and 2 the node points 200 are arranged in a body-centered cubic lattice. The coordination number thereof and thus the average number of struts emanating therefrom is 8.

The average minimum angle between adjacent struts 100 may be ≥30° to ≤140°, preferably ≥45° to ≤120°, more preferably ≥50° to ≤100°. In the case of the body 10 shown in FIGS. 1 and 2 the minimum angle between the struts 100 is about 70.5° at all points (arccos(⅓)) as is derivable from trigonometric considerations of the angle between the spatial diagonals of a cube.

FIG. 3 shows a plan view of a composite article 1 according to the invention. Starting from the body shown in FIGS. 1 and 2 a polymer foam 301 is now present in the interior of the body in the space between the struts 100. The outside surfaces of the composite article 1 shown in FIG. 3 continue to show truncated node points having the reference numerals 201 and 202.

The construction of the body may, at least in the cases of uniform arrangement of the node points 200 in the space, also be described as a result of penetration of hollow channels through a previously solid body 20. Thus having reference to FIG. 4 the space 300 may be in the form of interpenetrating first 310, second 320 and third 330 channel groups, wherein a multiplicity of individual channels 311, 321, 331 run parallel to one another within their respective channel group and the first channel group 310, the second channel group 320 and the third channel group 330 run in different spatial directions.

The body 20 shown in FIG. 4 has a higher spatial density of node points 200 in the section thereof shown on the left-hand side of the figure than in the section thereof shown on the right-hand side of the figure. For improved clarity; the abovementioned embodiment is discussed with reference to the section shown on the right-hand side. An array 310 of individual channels 311, whose direction is indicated by arrows, runs through the body perpendicularly to the surface of the body facing it. It will be appreciated that not just the three channels identified by reference numerals but all channels extending through the body at right angles to the face specified are concerned.

The same applies to the channels 321 of the channel group 320 and the channels 331 of the channel group 330 which run perpendicularly to one another and perpendicularly to the channels 311 of the first channel group 310. The material of the body remaining between the interpenetrating channels 311, 321, 331 forms the struts 100 and node points 200.

It is possible for the individual channels 311, 321, 331 to have a polygonal or round cross-section. Examples of polygonal cross-sections are triangular, quadrangular, pentagonal and hexagonal cross-sections. FIG. 4 shows square cross sections of all channels 311, 321, 331. Also possible is that within the first 310, second 320 and third 330 channel group the individual channels 311, 321, 331 each have the same cross section. This is shown in FIG. 4.

Likewise possible is that the cross section of the individual channels 311 of the first channel group 310, the cross section of the individual channels 321 of the second channel group 320 and the cross section of the individual channels 331 of the third channel group 330 are different from one another. For example the channels 311 may have a square cross section, the channels 321 may have a round cross section and the channels 331 may have a hexagonal cross section. The cross section of the channels determines the shape of the struts 100, so that in the case of different cross-sections different characteristics of the body 20 according to spatial directions may also be achieved.

In one variant the spatial density of the node points 200 in a first region of the body 20 may be different from the spatial density of the node points 200 in a second region of the body 20. This is shown schematically in the one-piece body 20 according to FIG. 4. As mentioned previously the body 20 shown therein has a higher spatial density of node points 200 in the section thereof shown on the left-hand side of the figure than in the section thereof shown on the right-hand side of the figure. Only every second node point 200 of the left-hand section forms a strut 100 to a node point 200 of the right-hand section,

FIG. 5 shows a plan view of a composite article 2 according to the invention. Starting from the body shown in FIG. 4 a polymer foam 301 is now present in the interior of the body in the space between the struts 100. The outside surfaces of the composite article 2 shown in FIG. 5 continue to show truncated node points having the reference numerals 201 and 202.

A further example of a composite article according to the invention not shown in the figures would be a ball such as for example a football. A body produced by 3-D printing as the inner structure having a treelike branching network of struts and node points is foam-filled in a spherical foaming mold so as to form an integral foam having a closed surface. The foam may have a compressive strength (40% compression, DIN EN ISO 3386-1:2010-09) of ≤100 kPa and a density of ≤30 g/l.

1.-16. (canceled)

17. A composite article comprising a body and a solid foam,
wherein
the body has been produced by means of an additive manufacturing process and has at least a positive fit to the foam, wherein the material of the body is different from that of the foam.

18. The composite article as claimed in claim 17, wherein the body comprises a spatial network of node points joined to one another by struts and a space present between the struts, the space present between the struts is at least partially occupied by a solid polymer foam and the body is at least partially formed from a polymeric material different from the polymer foam.

19. The composite article as claimed in claim 18, wherein the body is at least partially formed from a polymeric material selected from the group of: thermosetting polyurethanes, epoxides, polyacrylates, polyurethane acrylates, thermoplastic polyamides, thermoplastic polyesters, polyvinyl acetate, polystyrene, polyethylene, polypropylene, polyoxymethylene, polyvinyl chloride, polyurethanes, polyacrylates, polyether ether kethones, polyetherimides, olefin-based thermoplastic elastomers (TPO), styrene block copolymers (TPS), urethane-based thermoplastic elastomers (TPU), olefin-based crosslinked thermoplastic elastomers (TPV), polyvinyl chloride-based thermoplastic elastomers (PVC), silicone-based thermoplastic elastomers, sulfur- or oxygen-crosslinked elastomer/rubber raw materials and a combination of at least two of the aforementioned materials.

20. The composite article as claimed in claim 19, wherein the polymeric material is a thermoplastic elastomer and has a melting range (DSC, differential scanning calorimetry; second heating at a heating rate of 5 K/min) of ≥20° C. to ≤240° C., has a Shore hardness according to DIN ISO 7619-1 of ≥40 A to ≤80 Shore D and has a melt volume rate (MVR) according to ISO 1133 (240° C., 10 kg) of ≥25 to ≤250 cm³/10 min.

21. The composite article as claimed in claim 19, wherein the elastomer is a thermoplastic elastomer and has a melting range (DSC, differential scanning calorimetry; second heating at a heating rate of 5 K/min) of ≥20° C. to ≤240° C.,
has a Shore hardness according to DIN ISO 7619-1 of ≥40 Shore A to ≤80 Shore D,
has a melt volume rate (MVR) according to ISO 1133 (10 kg) at a temperature T of 5 to 15 cm³/10 min and
exhibits a change in the melt volume rate (10 kg) at an increase of this temperature T by 20° C. of ≤90 cm³/10 min

22. The composite article as claimed in claim 19, wherein the polymeric material is a thermoplastic elastomer and has a melting range (DSC, differential scanning calorimetry; 2nd heating at a heating rate of 5 K/min) of ≥20° C. to ≤100° C. and a magnitude of complex viscosity |η*| (determined by viscometry measurement in the melt with a cone/plate oscillation shear viscometer at 100° C. and a shear rate of 1/s) of ≥10 Pas to ≤1 000 000 Pas.

23. The composite article as claimed in claim 19, wherein the polymeric material is a thermoplastic polyurethane elastomer obtainable from the reaction of a polyisocyanate component and a polyol component, wherein the polyol component comprises a polyesterpolyol having a no-flow point (ASTM D5985) of ≥25° C.

24. The composite article as claimed in claim 18, wherein the composite article (1, 2) has a compression set after 10% compression (DIN ISO 815-1) of ≤2%.

25. The composite article as claimed in claim 19, wherein the polymeric material is a crosslinked polyacrylate crosslinked by means of free-radical crosslinking proceeding from liquid starting products in the presence of photoinitiators by the action of actinic radiation.

26. The composite article as claimed in claim 18, wherein in the body (10, 20) the struts (100) have an average length of ≥200 μm to ≤200 mm, the struts (100) have an average thickness of ≥100 μm to ≤5 mm and the body has in at least one spatial direction a compressive strength (40% compression, DIN EN ISO 3386-1:2010-09) of ≥10 to ≤1000 kPa.

27. The composite article as claimed in claim 18, wherein in the body the node points are distributed in a periodically repeating manner in at least a portion of the volume of the body.

28. The composite article as claimed in claim 18, wherein in the body the spatial density of the node points in a first region of the body is different from the spatial density of the node points in a second region of the body.

29. The composite article as claimed in claim 17, wherein the body is fully embedded in the foam so that the body does not protrude from the foam at any point.

30. The use of a composite article as claimed in claim 17 as a supporting element and/or mounting element.

31. A process for producing a composite article as claimed in claim 17 comprising the steps of:
I) producing a body by means of an additive manufacturing process;
II) contacting the body with a foam-forming composition, wherein the composition at least partially penetrates into the interior of the body;
III) forming a foam to obtain the composite article.

32. A process for producing a composite article as claimed in claim 18 comprising the steps of:
I′) producing a body by means of an additive manufacturing process, wherein the body comprises a spatial network of node points joined to one another by struts and a space present between the struts;
II′) contacting the body with a reaction mixture which reacts to afford a polymer foam, wherein the reaction mixture at least partially penetrates into the space between the struts of the body;
III′) reacting the reaction mixture to afford a polymer foam to obtain the composite article, wherein the body is at least partially formed from a polymeric material different from the polymer foam.
